(19) United States
(12) Patent Application Publication
(10) Pub. No.: US 2018/0293616 A1
(43) Pub. Date: Oct. 11, 2018

(54) SYSTEM AND METHODS FOR OBTAINING AND COMPILING TARGET CONSUMER INPUT FROM ADVERTISING MEDIA

(71) Applicant: Adam Greenhood, Albuquerque, NM (US)

(72) Inventor: Adam Greenhood, Albuquerque, NM (US)

(21) Appl. No.: 15/483,604

(22) Filed: Apr. 10, 2017

(51) Int. Cl. G06Q 30/02; G06Q 50/00

(52) U.S. Cl. CPC G06Q 30/0258; G06Q 50/01; G06Q 30/0267

(57) ABSTRACT

System/methods enable advertisements to be directly provided to consumers (“users) and/or embedded in a video entertainment program rendering on a consumer's electronic device for a consumer to selectively view and can include an embedded link to an advertisement server accessible via a data network wherein the advertisement can access questions stored in a database regarding the advertisement. A user can selectively review the advertisement and then can be provided with at least one question about the advertisement from the advertisement server after the advertisement has completed rendering on the consumer device. The user can provide an answer to the at least one question (or a minimum set by the advertiser), and can earn compensation if the user's answer(s) is/are found to be correct by the advertisement server. Questions can be targeted (e.g., based on a registered consumer's profile) or can be provided randomly.

### TECHNICAL FIELD

The present invention is related to advertising and the capture of feedback data from advertisements. More particularly, the present invention is related to systems and methods enabling an increase in advertisement feedback from consumers of media via targeted advertisements.

### BACKGROUND

Advertising is a critical component of business. Advertising is provided in a mix of text, audio, and video formats. Advertising is a multimedia experience for consumers. Consumers face multiple impressions, from television and radio to pop-up Internet advertisements, for products and services from marketers. The only reason marketers spend billions of dollars on advertising each year is to get the consumers' attention. According to Advertising Age, U.S. television advertisement spending was $179 billion in 2015 and $186 billion in 2016; yet, traditional television viewing trends among 18-24 year olds has consistently dropped from about 28% in the year 2011 to less than 15% in 2016.

According to state of the Industry reporting in 2016, consumers can only recall as little as 3% of advertisements they view each day. In addition to the lack of attention given to advertisements, even with a captive audience typical with live broadcasted television, advertisements viewed on live broadcasted television are often being avoided by a growing audience that is viewing programs online with portable computers or recorded content on a DVR (digital video recorder). Although paid online advertisements have been shown to be more effective, consumers often either fast-forwarded through the advertisements or press the “Skip Ad” button as soon as it is available in order to enable the viewer to avoid watching the advertisements.

The current state of advertising is concerning for marketers and businesses that actually pay significant money for their advertisements. The target audience is not effectively being reached given the conventional means of advertisement delivery, and paid online video advertisements, although more effective for consumer retention, can most often be skipped. Furthermore, effectiveness hinges on more than just reach. Ideally, advertising would somehow interactively engage the consumer in order to be most effective. There are no means available in what is conventional for the advertising industry today, however, to effectively validate that an advertisement has actually captured the attention of consumers.

In light of the foregoing, what is needed are new means to more effectively capture consumer attention over advertisements, obtain feedback that the consumer has seen advertisements, and which can reasonably be expected to increase the advertising industry's return on investment for its business customers.

### BRIEF SUMMARY OF THE EMBODIMENTS

The following summary is provided to facilitate an understanding of some of the innovative features unique to the disclosed embodiments and is not intended to be a full description. A full appreciation of the various aspects of the embodiments disclosed herein can be gained by considering the entire specification, claims, drawings, and abstract as a whole.

The only reason marketers spend billions of dollars on advertising is to get consumer attention, but it is already very well established that few consumers (practically nobody) pays attention to advertisements. The present inventor has expanded the capabilities of securing consumer attention to advertisements and also retrieving feedback from consumer of multimedia entertainment and advertisements. Rather than paying billions of dollars to television, social media, radio, outdoor billboard and print advertising networks, the present features of the inventive embodiments provides system and methods wherein the consumer is paid for feedback. Therefore, consumers can be paid for their attention, rather than being asked to pay attention given features of the present embodiments. Furthermore, advertisements can be better targeted to consumers where advertisers can set detailed target parameters (e.g., geographical, social, age, gender, etc.) that can be matched against user profiles. Advertisers can achieve better control of their budgets through control over the maximum spend per engagement and the number of engagements. Data can be collected and can be used by advertisers to better focus messages and enhance audience targeting.

In accordance with a feature of the embodiments, advertisements can be provided from an advertisement server to registered users for review on their electronic devices. A user can selectively reviews an advertisement and then can be provided with at least one question about the advertisement from the advertisement server after the advertisement has completed rendering on the user's electronic device. The user can provide answers to the at least one question, and can earn compensation to the user's account if a minimum number of correct answers set by the advertiser in the advertisement server are received in the user's answers.

In accordance with another feature of the embodiments, notification of pending advertisements can be provided to users registered with an advertising service to review advertisements on their mobile devices. A user can select an advertisement for review from their mobile device after notification, can provide answers to questions provided from the advertiser on the mobile device, and can be compensated to an account associated with the user if a minimum number of questions are deemed to be correct by the advertisement server.

In accordance with yet another feature of the embodiments, advertisements can be provided to targeted users based on a profile for users registered with an advertising service. The advertisements can be provided as video for rendering on targeted, registered users via their electronic device for the targeted registered users to review. The advertisements can be linked to an advertisement server accessible via a data network wherein the user's account/profile can be stored. Advertisements and related questions can be stored on the same advertisement server, or can also be obtained from other servers. The advertising server (or other servers related to the advertising service) can provide questions retrieved from a database regarding an advertisement viewed by the user. The user that selectively reviews an advertisement and answers at least one question (or a minimum number of questions set by the advertiser in the advertisement server) about the advertisement from the advertisement server after the advertisement has completed rendering on the user's electronic device can earn compensation if the user's answer is (or answers are) found to be correct by the advertising service (e.g., the advertisement server).

In accordance with another feature of the embodiments, an advertisement can be embedded in a video entertainment program rendering on a consumer device for a user to selectively view on the user's electronic device and can include an embedded link to an advertisement server accessible via a data network wherein the advertisement can access questions stored in a database regarding the advertisement. A user can selectively review the advertisement on their electronic device and then can be provided with at least one question about the advertisement from the advertisement server after the advertisement has completed rendering on the consumer device. The user can provide an answer to the at least one question, and can earn compensation if the user's answer is found to be correct by the server for a minimum number of questions set by a creator of the advertisement.

In accordance with another feature of the embodiments, questions can be targeted to the consumer based on a user's profile, or the questions can be provided randomly to consumers.

In accordance with another feature of the embodiments, a user's electronic devices (i.e., consumer devices) can include any of mobile phones, tablet computers, laptop computers, desktop computers, flat panel television sets (e.g., smart TVs), and set top boxes.

In accordance with another feature of the embodiments, user electronic devices can access and interact with advertisement over wireless and wired data communications networks.

In accordance with features of the embodiments, advertisers can access a dashboard to set up, manage and control advertisements. Advertisers can determine: if their advertisements are actually seen, whether the consumers are paying attention to advertisements, whether the consumer did anything after seeing the advertisement (e.g., request more info, coupons, make purchases, share ads), and more accurately measure their return on investment.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a system architecture in accordance with an example embodiment;

FIG. 2 illustrates features an electronic device, in accordance with an example embodiment;

FIG. 3A-3L illustrates photographs of screenshots from a mobile electronic device that are exemplary of certain aspects of the embodiments;

FIG. 4 illustrates a schematic view of a computer system, in accordance with an embodiment;

FIG. 5 illustrates a schematic view of a software system including a module, an operating system, and a user interface, in accordance with an embodiment;

FIG. 6 illustrates a flow diagram of a method, in accordance with features of the embodiments;

FIG. 7 illustrates a flow diagram of another method, in accordance with features of the embodiments; and

FIG. 8 illustrates a flow diagram of yet another method, in accordance with features of the embodiments.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is therefore not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation”.

The disclosed example embodiments expand capabilities of online advertising services beyond what is conventional or presently known when using electronic devices to review advertisements from advertisers. The example embodiments enable a broader perspective than has been possible. Whether a user is utilizing a portable computer, such as a smartphone or tablet, a desktop computer, a flat panel television set, a set top box, or a wearable camera, video of live advertisements and obtaining feedback and verification that advertisements have been reviewed is now possible given the present embodiments.

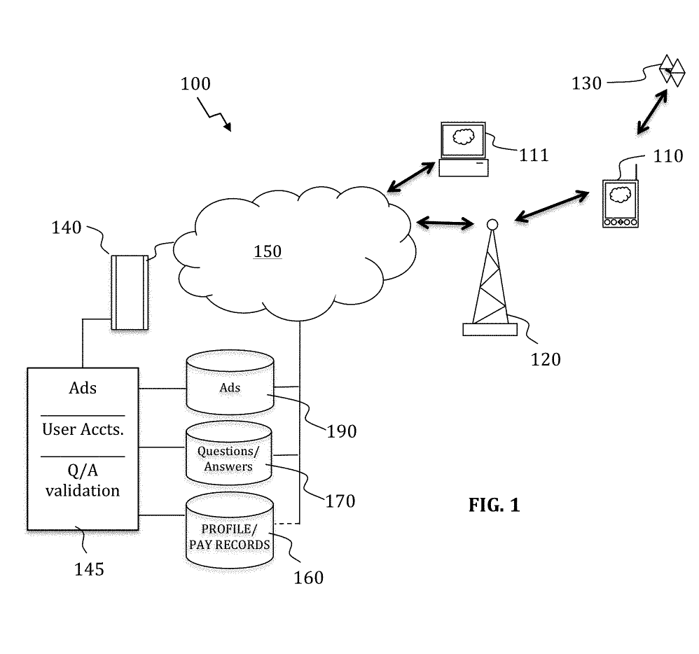

Referring to FIG. 1, a diagram of a system architecture 100 is shown in accordance with the preferred embodiments. A user can access advertisements using a computer 111 or mobile device 110 from a remote advertisement server 140 via a data communications network 150. The mobile device 110 can be provided in the form of a smartphone or tablet computer. The desktop computer 111 can also be provided in the form of a laptop computer. The desktop computer 111 can also represent a flat panel television set or set top box capabilities referred to in some embodiments. A desktop 111 can generally access a remote server 140 via direct connection to data network 150 (e.g., Internet, cable television, Wi-Fi router), whereas a mobile device 110 can generally access the data network 150 via cellular data communications infrastructure 120 (e.g., Wi-Fi router, cellular LTE, 4G, GSM, CDMA, etc.). Where a mobile device 110 is used, location based information can be determined via GPS satellites 130. Location information can be used to enhance the targeting of advertisements to registered users that is location-based. Other ways of determining mobile device location are cellular tower or hotspot triangulation, or IP address connections. With IP connection information, desktop 111 locations can also be determined. Information provided by users via mobile device 110 or desktop 111 related to a subject such as answers to questions about reviewed advertisements can be provided to the server where it is further processed by software modules 145.

The software modules 145 can also be referred to as an “advertisement module” that specially configures the server 140 with unique capabilities described herein. In particular, the software modules can enable the creation and storage of advertisements and questions by advertisers, enable the creation of user accounts (e.g., registered user, obtain demographic information, identify associated electronic devices), and validate answers provided by user for the correctness. The server 140 and software modules 145 to achieve the unique features of the embodiments can access one or more databases. An advertisement database can store the creative work of advertisers in video and text formats. A question answer database 170 can store questions and correct answers associated with the advertisements. A user registration database 160 can store user profile and account information therein. Once specially configured, the advertisement server 140, working together with the software modules 145 and database(s), can, via the data network 150, enable the presentation of advertisements to registered users on electronic devices 110/111 associated with the registered users, provide questions associated with advertisements presented to the registered users to the electronic devices 110/111, obtain answers to the questions from the registered users input via the electronic devices 110/111, check for accuracy of the answers obtained from the registered users by comparing the answers with the correct answers, and provide the registered users with compensation in an account associated with the users if the answers are deemed correct by the advertising server after the advertising server matches the answers against the correct answers.

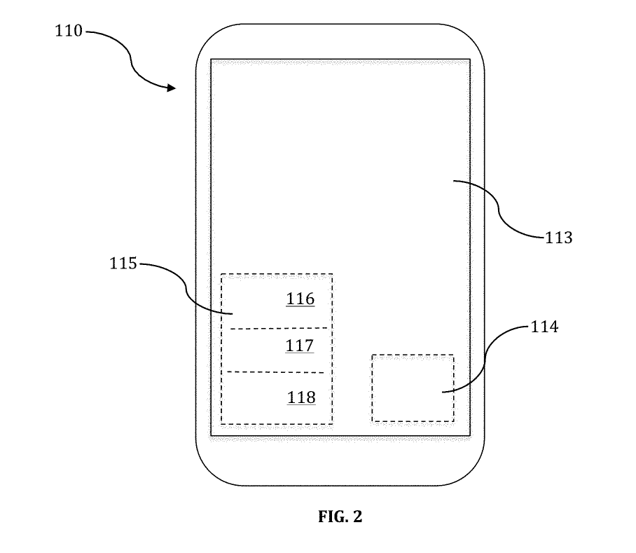

Referring to FIG. 2, illustrated is a portable handheld device 110, which can be used by user in accordance with features of the embodiments. The mobile device 110 includes a touch-sensitive display screen 113, a microprocessor 116, and memory 117. Additionally, an advertisement application program 118 can be provided via download to the mobile device to enable registered user interaction with the advertisement server 140 and its unique services. A wireless communications module 114 provides communications of the mobile device 114 with data communications network 150, and can also provide GPS location information.

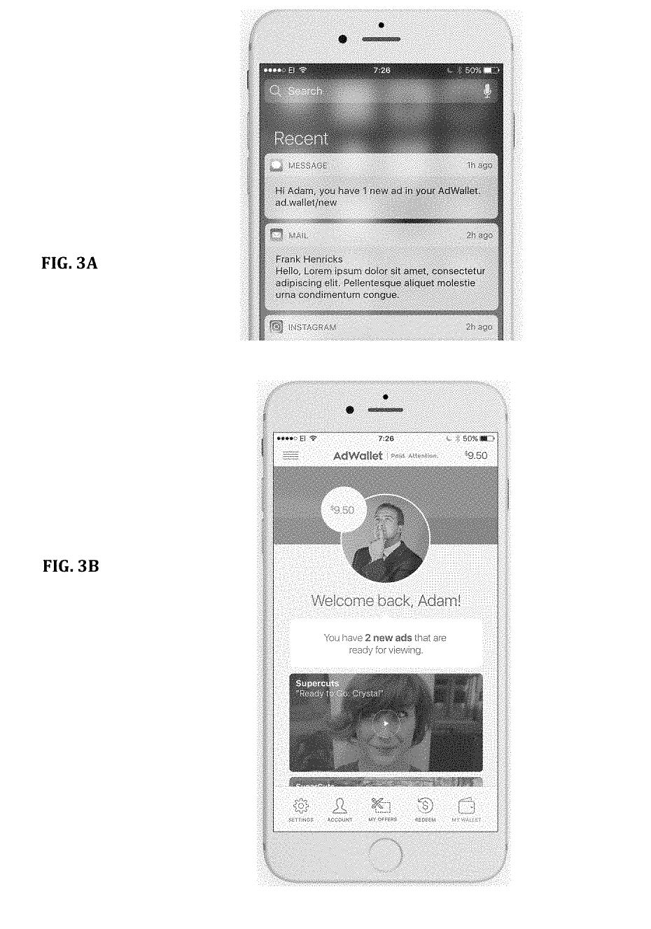

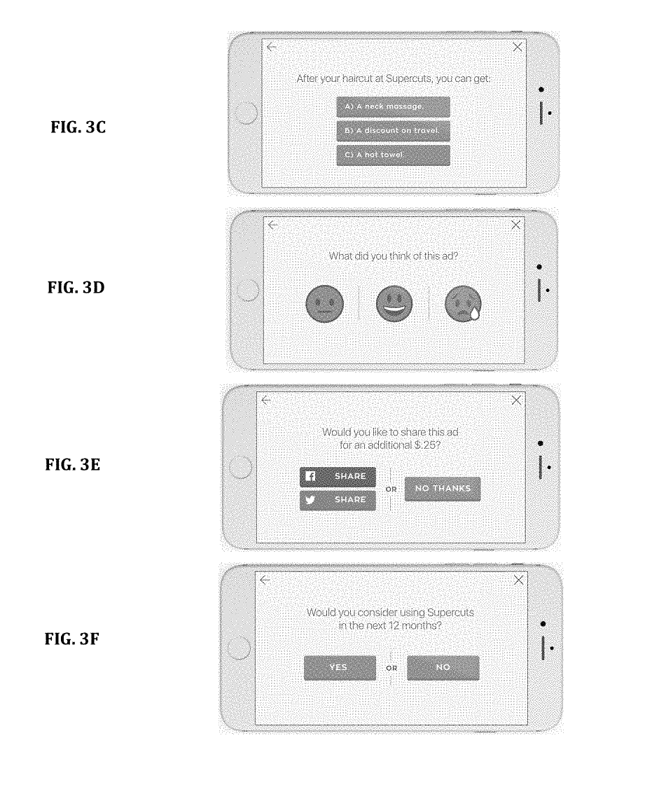

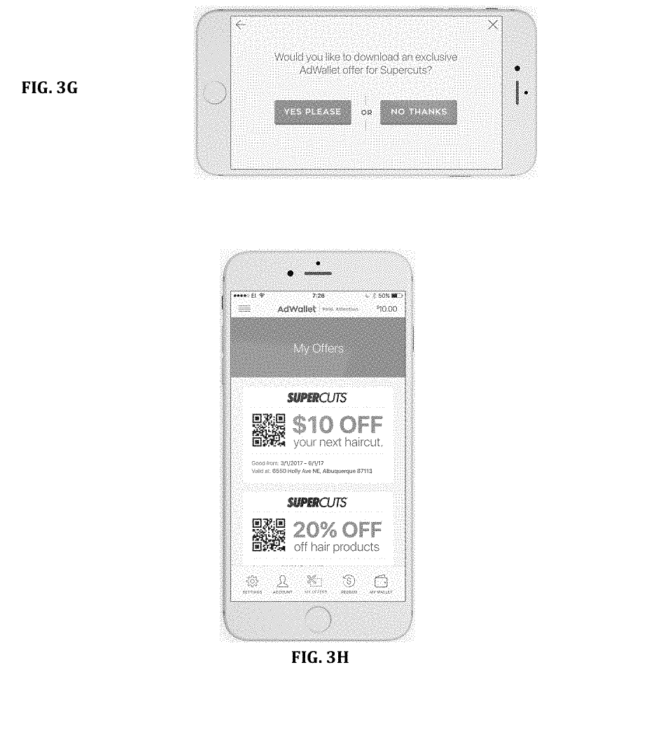

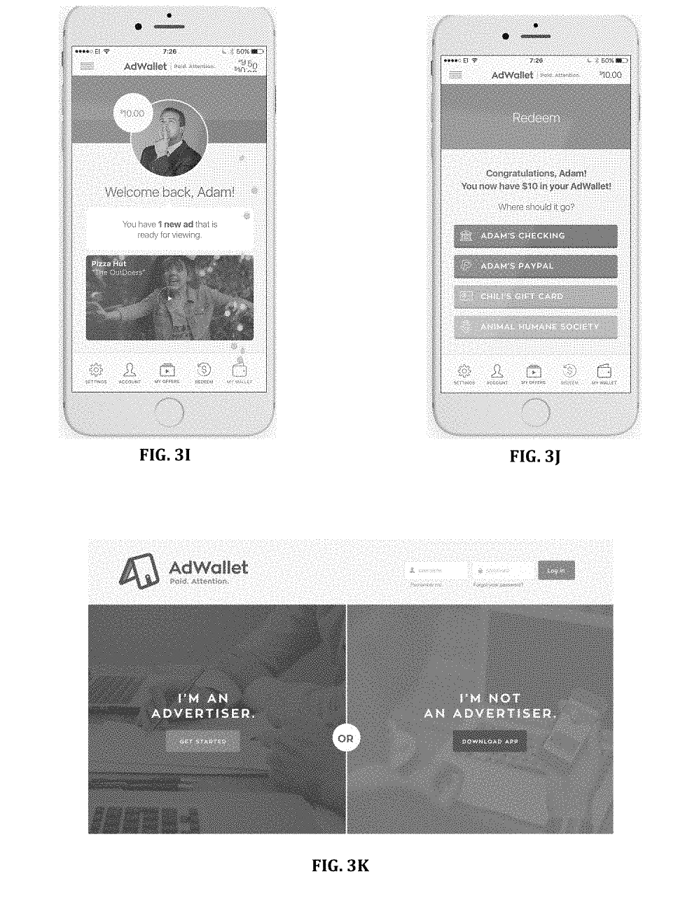

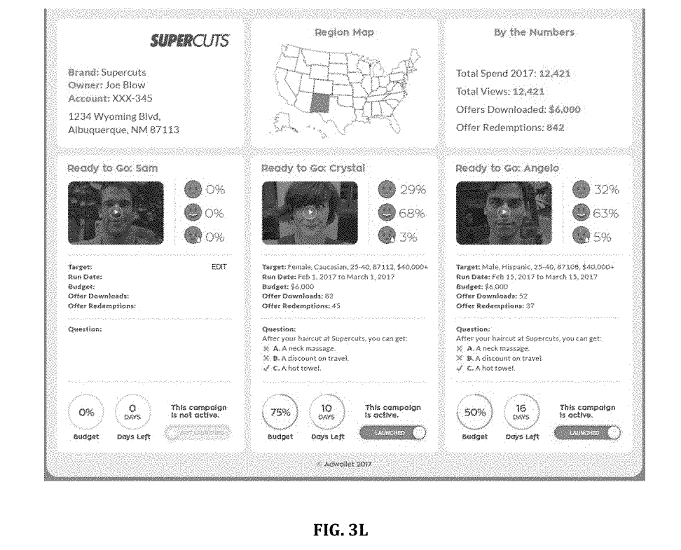

FIGS. 3A-3L represent photographs of screenshots from an electronic device (e.g., mobile device 110 or desktop 111) provided as examples of certain features of the embodiments. FIGS. 3A-3L are provided for exemplary purposes only and should not be interpreted in a manner that would limit the embodiments to a particular, system, platform or process. As indicated in FIG. 3A, an electronic device in accordance with the embodiments can receive an electronic message on behalf of its user (“Adam”) indicating that one new advertisement is available it's the user's account with an advertisement service (“AdWallet”). For purposes of the example, it can be assumed that the user is registered with the advertising service that provides advertisements to registered user for their review and that the user has opted to be notified when a new advertisement is available. The user can open the message or application associated with the advertisement service, which can then direct the user to the screenshot illustrated in FIG. 3B, wherein the user's balance ($9.50) is indicated and pending adds to review are shown (“2 new ads that are ready for viewing”). Also shown is an advertisement with a play button (arrow button) that the user can select by touching the touchscreen and begin reviewing the ad (Supercuts “Ready to Go: Crystal”). After the advertisement has been reviewed, the user will be provided a question as shown in FIG. 3C. The example question is shown in a multiple-choice format with a correct answer being based on what the user reviewed in the advertisement video. As shown in FIG. 3D, the user can also be asked to provide a rating of the advertisement (neutral, good, and bad indicated by emoticons). As shown in FIG. 3E, the user can also opt to share the advertisement with the user's social network for additional compensation ($0.25) by selecting a social application soft button (e.g., Facebook, Twitter) for sharing the ad, or by selecting a button to declining (“No Thanks”). Moving on the FIG. 3F, the user can also be asked if they would consider using the product or service highlighted in the advertisement that the user reviewed. Assuming the user selects “Yes”, the user can then be offered a coupon as illustrated in FIG. 3G. If the user chooses to download a coupon from the advertising service, then a coded coupon can be provided on the mobile device as illustrated in FIG. 3H. FIG. 3I illustrates a screen shot of the user's advertisement service application after going through the options of reviewing and answering questions regarding the review advertisement. As shown in FIG. 3I, the user's balance is now updated ($10.00), indicating that the correct answer was provided and that the user got credit for reviewing the advertisement. Also updated is the number of advertisement awaiting review (“You have 1 new ad that is ready for viewing”). Finally, as shown in FIG. 3J, the registered user can be provided with options (before, during or after review and before exiting) for redeeming earned credit. FIG. 1 provides example options of transferring earned compensation to accounts associated with the user such as a checking account, PayPal, obtaining gift cards, or donation to a good cause.

Referring to FIG. 3K, a photograph of a screen shot typical of what an advertiser or registered user would see when logging into a desktop computer is shown. There is a general log in for registered user, whether the users are advertisers and reviewers. There is also an entry portal for advertisers and an entry portal for other parties (such as vendors desiring entry into the system) to obtain information about the advertising service. FIG. 3L is a photograph of a screenshot for what an advertiser will typically see when logged into the advertising system. An advertiser can manage their advertisements (i.e., create ads, create questions) and review their effectiveness (i.e., review ratings). The advertiser can also activate and inactivate advertising campaigns from the user interface.

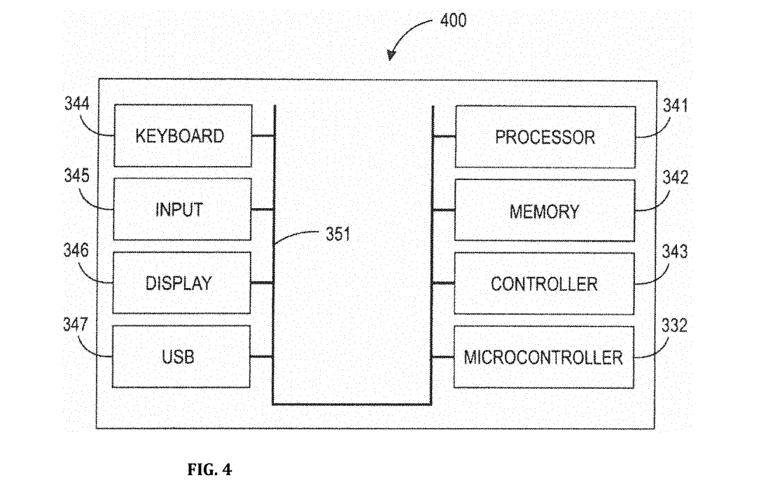

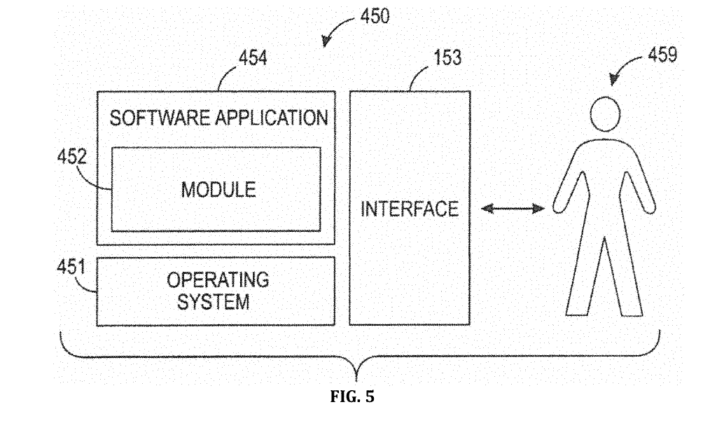

FIGS. 4-5 are shown only as exemplary diagrams of data-processing environments in which example embodiments may be implemented. It should be appreciated that FIGS. 4-5 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 4, some embodiments may be implemented in the context of a data-processing system 400 that can include, for example, one or more processors such as a processor 341 (e.g., a CPU (Central Processing Unit) and/or other microprocessors), a memory 342, an input/output controller 343, a microcontroller 332, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.) and/or other peripheral connections and components.

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc.).

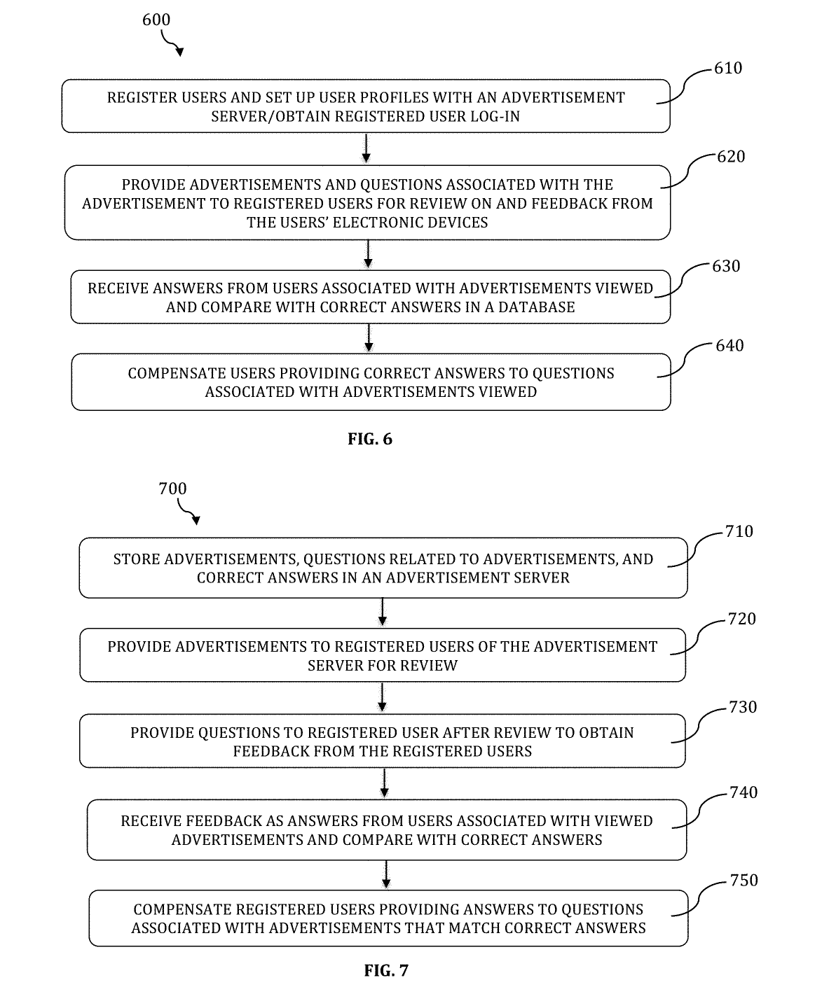

FIG. 5 illustrates a computer software system 450 for directing the operation of the data-processing system 400 depicted in FIG. 7. Software application 454, stored for example in memory 342, generally includes a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement instructions or operations such as those discussed herein. Module 452 may also be composed of a group of modules.

Referring to FIG. 6, a flow diagram 600 is shown for a method in accordance with features of the preferred embodiments. As shown in Block 610, registered users can register and set up a user profile with an advertisement server, or alternatively can log-into the advertisement server and access services if the users are already registered. As shown in Block 620, the advertisement server can provide advertisements and questions associated with the advertisement to registered user for their review and feedback using the users' electronic devices. As shown in Block 630, the advertisement server can receive answers associated with reviewed advertisements viewed from users and compare the received answers with correct answers associated with the viewed advertisements that can be stored in a database. Then as shown at Block 640, the advertisement server can direct providing compensation to user providing correct answer to the questions associated with view advertisements.

Referring to FIG. 7, another flow diagram 700 is illustrated in accordance with features of the embodiments. As shown in Block 710, advertisements, questions related to the advertisements, and correct answers can be stored in an advertisement server. This step can be conducted by advertising service creative personnel. Once stored, an advertising campaign can begin. Advertisers can provide advertisements to registered users of an advertisement service from the advertisement server (or service) for their review as shown in Block 720. As shown in Block 730, the advertisement server can provide questions to registered users after their review of advertisements to obtain feedback from the registered users regarding the advertisements. The advertisements server then receives feedback in the form of answers from users associated with the view advertisements and the server compares the answer with correct answers, as shown in Block 740. Then as shown in Block 750, the registered users providing the answers to questions associated with advertisement receive compensation from the advertisement service (server) if their answers match correct answers.

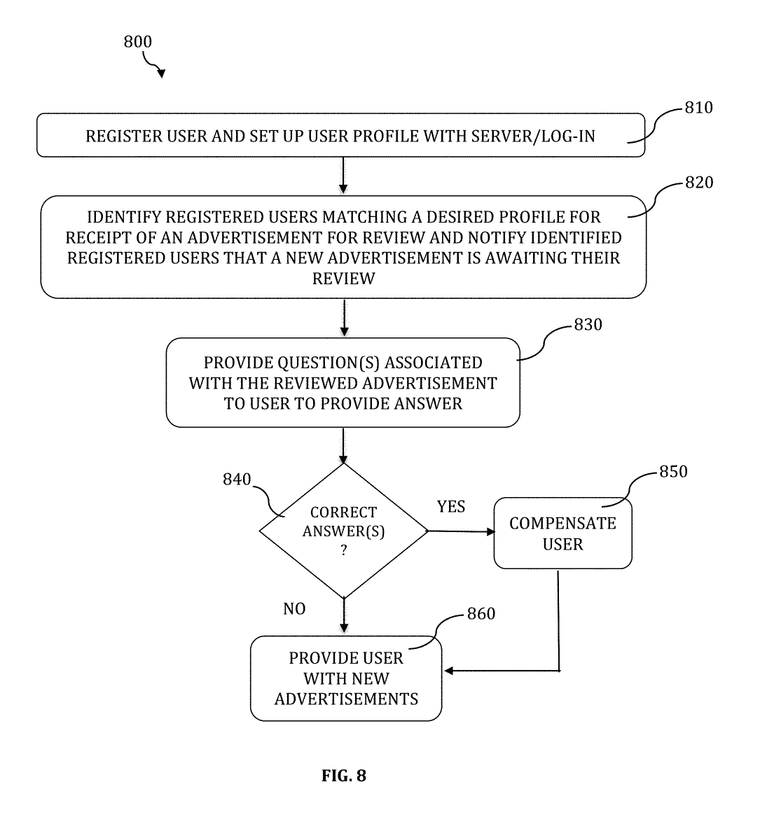

Referring to FIG. 8, another flow diagram 800 in accordance with features of the embodiments is illustrated. As shown in Block 810, users interested in reviewing advertisements from an advertisement service can be registered with their profile information in an advertisement server, or already registered users can log into the advertisement server. Once log into the system as registered users, the advertisement server can identify registered users matching a desired profile for receipt of an advertisement for review and can notify identified registered that a new advertisement is awaiting their review. The advertisement server can also provide at least one question associated with the reviewed advertisement for the registered user to answer, as shown in Block 830. As shown in Block 840, the advertisement server checks any answers provided by the user against correct answer stored in a database. If the minimum amount of answers set by the advertisement server is determined to be correct, then the user is compensation as shown in Block 850. If the minimum amount of answers provided by the user is not correct, then the server can provide the user with new advertisements as shown in Block 860. New advertisements can be provided to user answering questions correctly as also indicated in the FIG. 8.

As can now be appreciated by one skilled in the art, some example embodiments can be implemented in the context of a method, data processing system, or computer program product. Accordingly, some example embodiments may take the form of an entire hardware embodiment, an entire software embodiment, or an embodiment combining software and hardware aspects all generally referred to herein as a “circuit” or “module.” Furthermore, some example embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, on a server as a remote computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi, Wimax, 802.xx, and cellular network or the connection may be made to an external computer via most third party supported networks (for example, through the Internet utilizing an Internet Service Provider).

The example embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 4-5 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example as a set of operations to be performed by a computer. Such operational/functional description in most instances can be specifically configured hardware (e.g., because a general purpose computer in effect becomes a special-purpose computer once it is programmed to perform particular functions pursuant to instructions from program software). Note that the data-processing system or apparatus discussed herein may be implemented as special-purpose computer in some example embodiments. In some example embodiments, the data-processing system or apparatus can be programmed to perform the aforementioned particular instructions thereby becoming in effect a special-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (E.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a micro architecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “1111000100101110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state, may be used to construct a machine based on the above technical description. Charles Babbage, for example, constructed the first computer out of wood and powered by cranking a handle.

Thus, far from being understood as an abstract idea, it can be recognized that a functional/operational technical description as a humanly understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations can be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A system for increasing advertising effectiveness, comprising:
an advertisement server connected to a data communications network;
at least one database storing user registration information, advertisements, questions associated with the advertisements, and correct answers associated with the advertisements; and
an advertisement module specially configuring the advertisement server to register users, present advertisements to registered users on electronic devices associated with the registered users, provide questions associated with advertisements presented to the registered users to the electronic devices, obtain answers to the questions from the registered users input via the electronic devices, check for accuracy of the answers obtained from the registered users by comparing the answers with the correct answers, and provide the registered users with compensation in an account associated with the users if the answers are deemed correct by the advertising server after the advertising server matches the answers against the correct answers.

2. The system of claim 1, wherein an advertisement provided by the advertisement server to a registered user renders as video on a user electronic device.

3. The system of claim 1, wherein an advertisement provided by the advertisement server to a registered user includes a link to provide registered users access to information associated with the advertisement.

4. The system of claim 1, wherein the advertisement can be electively reviewed by the registered user after being notified by the advertisement server that the advertisement is available for review by the registered user.

5. The system of claim 1, wherein and the registered user can provide at least one answer to at least one question provided by the advertisement server in association with the advertisement for compensation if a minimum amount of answers provided by the registered user are determined to be correct when matched by the advertisement server against the correct answers.

6. The system of claim 1, wherein the user registration information includes at least one of: profile data, location information, payment account, and registration of electronic devices associated with registered users.

7. The system of claim 1, wherein the questions are randomly provided by the advertisement server to the user.

8. The system of claim 1, wherein the questions are targeted to the consumer by the advertisement server based on the user registration information.

9. The system of claim 1, wherein the advertisement provided to the registered user is embedded in a video entertainment program rendering and also being viewed by the registered user on the registered user's electronic device and the advertisement includes a link to the advertisement server providing access to the questions associated to the advertisement, wherein the advertisement can be electively reviewed by a registered user and the registered user can provide at least one answer to at least one question provided by the advertisement server in association with the advertisement for compensation if the at least one answer is deemed correct by the advertisement server.

10. A method for increasing advertisement effectiveness, comprising:
providing an advertisement to a registered user from an advertisement server, wherein the advertisement is accessible by an electronic device associated with the user from the advertisement server over a data network and the advertisement is tied to questions and correct answers that are stored in a database and are associated with the advertisement;
enabling the registered user to selectively review the advertisement on the electronic device;
providing the registered user with at least one question from the database after the advertisement has completed rendering on the electronic device;
receiving an answer at the advertisement server to the at least one question from the registered user provided via the electronic device and checking at the advertisement server whether the answer is correct by comparing the answer to the correct answers stored in the database; and
providing the registered user with compensation if the answer provided by the registered user is determined by the advertisement server to be correct.

11. The method of claim 10, wherein the advertisement provided to the registered user is embedded in a video entertainment program also rendering on the electronic device for the user's entertainment, and wherein the advertisement includes an embedded link to the advertisement server which is accessible over the data network and is tied to the questions and the correct answers stored in the database.

12. The method of claim 10, further comprising providing a link to the user for product or service information after receiving the answer.

13. The method of claim 10, further comprising providing a link to the registered user for the advertisement to be shared from the electronic device using a social network application and a social network associated with the registered user.

14. The method of claim 13, wherein the registered user is compensated for sharing the advertisement with a social network.

15. The method of claim 10, wherein the advertisement and the at least one question can be provided randomly by the advertisement server to registered users.

16. The method of claim 10, wherein the advertisement and the at least one question can be targeted by the advertisement server to registered users based on user profiles associated with the registered users.

17. The method of claim 10, wherein the electronic device is at least one of: a smartphone, a tablet computer, a laptop computer, a desktop computer, a set top box and a flat panel television set.

18. A method for increasing advertisement effectiveness, comprising:
providing an electronic notification over a data network from an advertisement service operating through an advertisement server to an electronic device associated with a registered user of the advertising service that a new advertisement is available for the registered user to selectively review;
receiving a request at the advertisement server from the registered user to review the new advertisement;
providing the new advertisement from the advertisement server to the registered user for the registered user to selectively review on the electronic device, wherein the advertisement is also tied to questions and correct answers associated with the advertisement that are stored in a database;
enabling the registered user to selectively review the advertisement on the electronic device;
providing the registered user with at least one question from the database after the advertisement has completed rendering on the electronic device;
receiving an answer to the at least one question from the registered user at the advertisement server provided via the electronic device and checking whether the answer is correct by the advertisement server by comparing the answer to the correct answers stored in the database; and
providing the registered user with compensation in an account associated with the registered user if the answer provided by the registered user is determined by the advertisement server to be correct.

19. The method of claim 18, wherein the registered user is provided with more than one question about the advertisement from an advertisement server after the advertisement has completed rendering on the electronic device and the registered user provides answers to the more than one question and earns compensation if a minimum number of answers set in the advertisement server for compensation are found to be correct by the advertisement server.

20. The method of claim 18, wherein the electronic device is at least one of: a smartphone, a tablet computer, a laptop computer, a desktop computer, a set top box and a flat panel television set.

21. The method of claim 18, where advertisements can be provided to registered users based on a profile associated with registered users of the advertising service.

22. The method of claim 18, wherein the advertisement provided to the registered user is embedded in a video entertainment program also rendering on the electronic device for the user's entertainment, and wherein the advertisement includes an embedded link to the advertisement server which is accessible over the data network and is tied to the questions and the correct answers stored in the database.

23. The method of claim 18, further comprising providing a link to the user for product or service information after receiving the answer.

24. The method of claim 18, further comprising providing a link to the registered user for the advertisement to be shared from the electronic device using a social network application and a social network associated with the registered user.

25. The method of claim 24, wherein the registered user is compensated for sharing the advertisement with a social network.
